(19) United States
(12) Patent Application Publication
(10) Pub. No.: US 2020/0034708 A1
(43) Pub. Date: Jan. 30, 2020

(54) GENERATION OF DATA FOR IMPROVING DETERMINATION ACCURACY OF A CLASSIFIER MODEL

(71) Applicant: FUJITSU LIMITED, Kawasaki-shi (JP)

(72) Inventor: Tetsuyoshi SHIOTA, Yokohama (JP)

(73) Assignee: FUJITSU LIMITED, Kawasaki-shi (JP)

(21) Appl. No.: 16/507,728

(22) Filed: Jul. 10, 2019

(30) Foreign Application Priority Data
Jul. 24, 2018 (JP) 2018-138522

(51) Int. Cl. G06N 3/08

(52) U.S. Cl. CPC G06N 3/08

(57) ABSTRACT

Chronological data having a first cycle including a set of unit times of a predetermined number is provided. Image data including a figure is generated based on the chronological data. The figure is generated such that respective sets of unit times included in the chronological data are arranged in a spiral in chronological order and unit times corresponding to a same position within the first cycle are radially aligned from the center of the spiral.

### CROSS-REFERENCE TO RELATED APPLICATION

This application is based upon and claims the benefit of priority of the prior Japanese Patent Application No. 2018-138522, filed on Jul. 24, 2018, the entire contents of which are incorporated herein by reference.

### FIELD

The embodiments discussed herein are related to generation of data for improving determination accuracy of a classifier model.

### BACKGROUND

In the past, there have been attempts to predict (classify) a trend in stock market and a tendency of presence/absence of recuperation of employees from chronological data by a machine learning approach using neural networks. In this prediction, graphic data representing chronological data to be a teacher is generated as data for learning, and a convolutional neural network (CNN), which is a classifier model, is learned. A prediction is performed based on an output obtained by inputting graphic data representing chronological data of a prediction target to the classifier model after learning.

For generation of data for learning used for training a classifier model, chronological data is divided into segments of overlapping data with an equal size, and images representing data in the segment are generated for each segment, and the trend relating to each image is determined. Techniques are known for storing each generated image and a trend associated with the image as a data set for a predictive analysis.

Examples of the related art include Japanese Laid-open Patent Publication No. 2017-157213 and Japanese Laid-open Patent Publication No. 2002-268971.

### SUMMARY

According to an aspect of the embodiments, chronological data having a first cycle including a set of unit times of a predetermined number is provided. Image data including a figure is generated based on the chronological data. The figure is generated such that respective sets of unit times included in the chronological data are arranged in a spiral in chronological order and unit times corresponding to a same position within the first cycle are radially aligned from the center of the spiral.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram for explaining training of a classifier model and prediction by the classifier model;

FIG. 2 is an explanatory diagram for explaining a neural network of a classifier model;

FIG. 3 is a block diagram illustrating an example of a functional configuration of a learning device according to an embodiment;

FIG. 4 is a flowchart illustrating an example of a learning phase;

FIG. 5 is an explanatory diagram for explaining an example of generation of work result graphic data from work data;

FIG. 6 is an explanatory diagram of an example of work result graphic data;

FIG. 7A is an explanatory diagram exemplifying work result graphic data in the related art;

FIG. 7B is an explanatory diagram exemplifying work result graphic data generated by a learning device according to an embodiment;

FIG. 8 is a flowchart illustrating an example of a prediction phase;

FIG. 9 is an explanatory diagram for explaining generation of a figure using a spectrum analysis result; and

FIG. 10 is a diagram of an example of a computer that executes a program.

### DESCRIPTION OF EMBODIMENTS

In the above-mentioned related art, since chronological data is divided by, for example, a break of one week from Sunday to Saturday in a calendar, it is difficult to express, by graphic data, the regularity of the event which is across the break, such as an event from Friday to Monday. For this reason, there is a problem that learning of an event or the like which is across a break does not progress in the classifier model, and the determination accuracy is lowered.

It is preferable to improve the determination accuracy of the classifier model.

Hereinafter, a data generation method, a data generation program, and a data structure according to an embodiment will be described with reference to the drawings. The components having the same function in embodiments are denoted by the same reference numeral, and the redundant description will be omitted. Note that the data generation method, the data generation program, and the data structure described in the following embodiments are merely an example, and do not limit the embodiments. In addition, each of the following embodiments may be combined as appropriate within the scope of no contradiction.

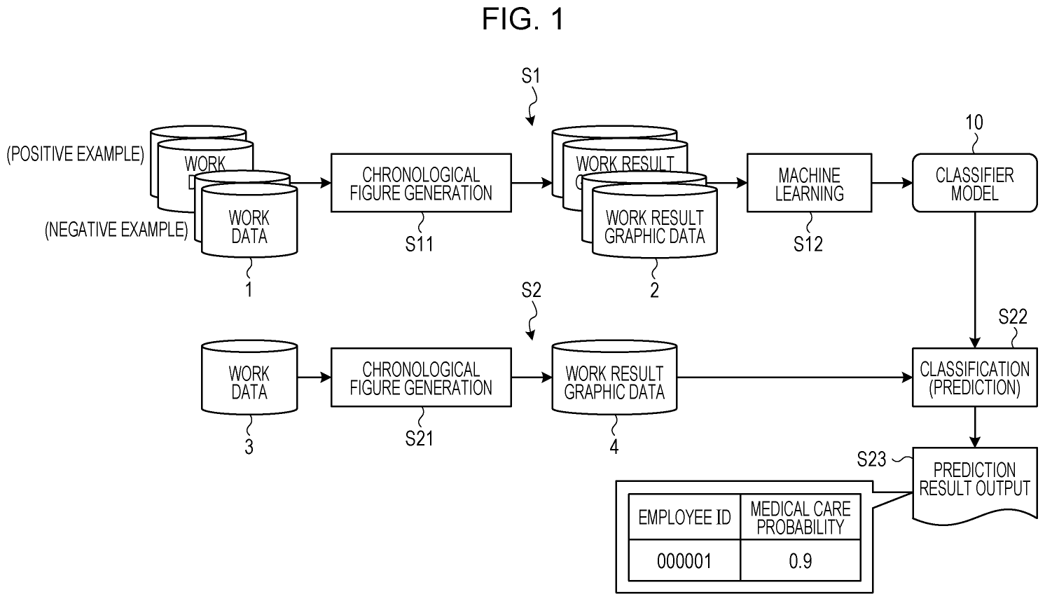

FIG. 1 is an explanatory diagram for explaining training of a classifier model and prediction by the classifier model. As illustrated in FIG. 1, a classifier model 10 is a CNN which performs learning with work data 1 as a teacher in a learning phase (S1), and predicts (classifies) a tendency from work data 3 of the prediction target in a prediction phase (S2).

The work data 1 and 3 is data indicating the work situation (events) such as daily work, leave time, leave acquisition, and business trip of an employee in chronological order, and is an example of chronological data. The chronological data such as the work data 1 and 3 has a cycle (for example, one week from Sunday to Saturday) composed of a plurality of time units (for example, one day).

In recent years, management of physical conditions of employees and the like has been positioned as an important matter to be addressed by companies, and a prediction of mental poor condition ahead of several months (presence or absence of medical care), and a support such as counseling at an early time are performed based on the work data 3 of employees. Dedicated staff members such as work support staff browse the work data 3 of a large number of employees, and visually look for employees who fall under patterns of working conditions featured by frequent business trips, long overtime work, continuous absences, an absence without notice, a combination thereof, and the like. Such feature patterns are difficult to clearly define, as the criteria may differ depending on each dedicated staff member.

Therefore, in the embodiment, as an example of a machine learning approach using CNN, training of the classifier model 10 is performed based on the work data 1 of unwell-conditioned persons (positive example) and well-conditioned persons (negative example). An example will be described in which the work data 3 of the prediction target is input to the classifier model 10 to predict a mental poor condition of the employee. The prediction target is not limited to this. For example, the present embodiment may be applied to a prediction target other than employees, such as failure prediction using operation data of electronic components, attack prediction using communication data, and traffic congestion prediction using traffic volume data of roads.

For example, in the learning phase (S1), based on the work data 1 to which a positive example or a negative example is assigned as correct answer information, a chronological figure obtained by representing events that occur in chronological order by a figure is generated for each case of the positive example or the negative example (S11). As a result, work result graphic data 2 representing a pattern of events occurring in chronological order as a figure is generated for each case of the positive example or the negative example.

Next, in the learning phase (S1), the generated work result graphic data 2 is input to an input layer of the classifier model 10, and the parameters of each layer in the classifier model 10 are adjusted so that the output from the output layer of the classifier model 10 indicates the positive or the negative example, whereby machine training of the classifier model 10 is performed (S12).

In the prediction phase (S2), as in S11, chronological figures are generated based on the work data 3 of the prediction target, and the work result graphic data 4 is generated (S21). Next, in the prediction phase (S2), the generated work result graphic data 4 is input to the input layer of the classifier model 10 to perform classification (prediction) such as the presence or absence of medical care as an unwell-conditioned person (S22). Next, in the prediction phase (S2), the prediction result obtained from the output layer of the classifier model 10 by the input of the work result graphic data 4 is output to a display or the like (S23).

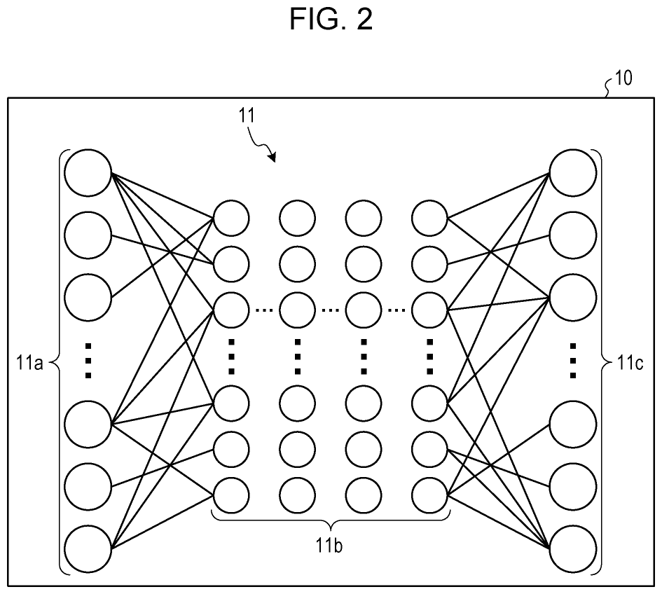

FIG. 2 is an explanatory diagram for explaining a neural network of the classifier model 10. As illustrated in FIG. 2, a neural network 11 of the classifier model 10 has a hierarchical structure and may have a plurality of intermediate layers 11b between an input layer 11a and an output layer 11c. The plurality of intermediate layers 11b include, for example, a convolution layer, an activation function layer, a pooling layer, a fully connected layer, and a softmax layer. The number and location of each layer may be changed at any time depending on the required architecture. For example, the hierarchical structure and the configuration of each layer of the neural network 11 may be predetermined by the designer according to the object to be identified. Therefore, the weight of at least one of the convolution layer, the activation function layer, the pooling layer, the fully connected layer, and the softmax layer in the neural network 11 is changed using the feature part in the graphic data, and a learned model for predicting a person who will receive medical care from events that occur within a cyclic time unit is generated.

For example, in the present embodiment, since the imaged work result graphic data 2 and 4 are input to the input layer 11a, the input layer 11a has a configuration for receiving image data of N×M pixels (N×M dimensions). The intermediate layers 11b has a configuration as a convolutional neural network (CNN) in which a convolution layer and a pooling layer are alternately stacked so as to enable feature extraction from the input image data.

The output layer 11c has a configuration in which classification results of an unwell-conditioned person (with medical care) or a well-conditioned person (without medical care) are output with respect to the input work result graphic data 2 and 4. For example, the output layer 11c outputs the probability degree of the presence or absence of medical care with respect to the input work result graphic data 2 and 4.

The calculation of the intermediate layers 11b will be described. The convolution layer performs a convolution operation (convolution processing) of the input neuron data to extract features of the input neuron data. For example, in the convolution layer, the value of each pixel of the N×M pixel image is taken as neuron data, and neuron data for output to the next layer is generated by calculating a convolution filter of size m×m with respective parameters set and a convolution.

For example, in the convolution layer, by performing the calculation, the more the feature of the feature part is similar with respect to the feature part arranged to be located radially from the center of the spiral figure, the higher score the feature part is weighed with. When the image corresponding to “work (workday)” among the events of a chronological figure 21 is more similar to an image corresponding to “work (workday)” than an image corresponding to “no work (workday)”, the score goes high.

The activation function layer emphasizes the feature extracted in the convolution layer. In the activation function layer, activation is modeled by causing the neuron data for output to pass through an activation function. The activation refers to a phenomenon in which a signal output when the value of a signal output from a neuron exceeds a certain value is transmitted to another neuron. As the activation function, a non-linear activation function may be used, and for example, a rectified linear unit (ReLU) (or a ramp function) may be used.

The pooling layer is placed, for example, immediately after the convolution layer, and the thinning is performed on input neuron data. Thus, the pooling layer has a function of reducing the position sensitivity of the extracted feature. For example, in the pooling layer, the thinning is performed by Max-Pooling that extracts the maximum value for each area of k×k. The thinning may be performed by any other method. For example, the thinning may be performed by Average-Pooling that extracts an average value of the area of k×k. In the pooling layer, the areas of k×k to be thinned may partially overlap each other, or the areas of k×k may be adjacently arranged without overlapping each other to perform the thinning.

In the fully connected layer, extracted features are connected and a variable indicating the feature is generated. In the fully connected layer, the calculation of a full connection is performed to fully connect input neuron data according to the number of targets to be identified. For example, an image of N×M pixels is input as neuron data. The fully connected layer multiplies all neuron data of the N×N pixels by weights (parameters), thereby generating neuron data for output to the next layer.

The softmax layer converts the variable generated in fully connected layer into a probability. The softmax layer models activation by executing a calculation of causing the neuron data for output to pass through an activation function such as a normalization function. A non-linear activation function may be used as the activation function used in the softmax layer, and for example, the Softmax function may be used. The neuron data of the calculation result by the softmax layer is output to the output layer 11c, and the identification is performed in the output layer 11c.

The learning phase (S1) and the prediction phase (S2) in the above-described classifier model 10 are performed by a learning device such as a computer that executes a program.

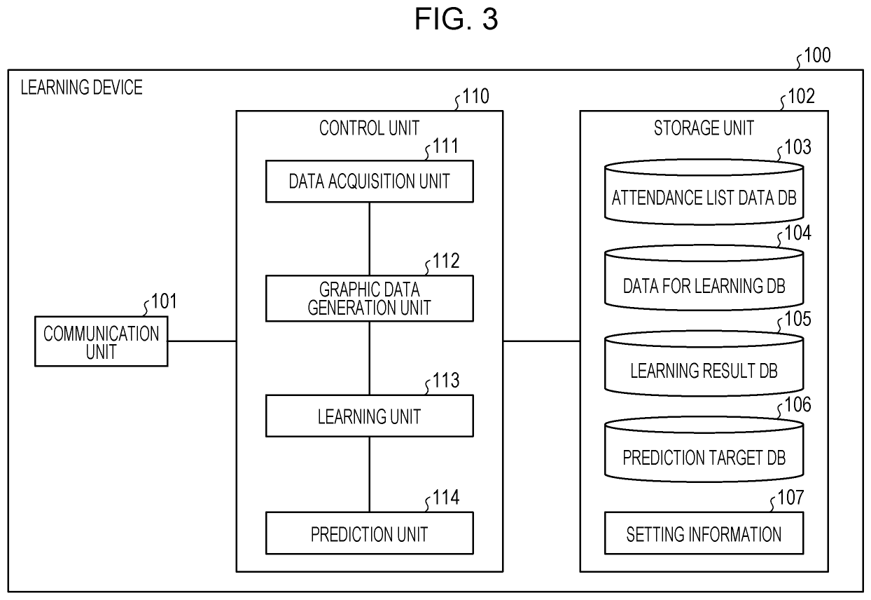

FIG. 3 is a block diagram illustrating an example of a functional configuration of a learning device according to an embodiment. As illustrated in FIG. 3, a learning device 100 includes a communication unit 101, a storage unit 102, and a control unit 110.

The communication unit 101 is a processing unit that controls communication with another device, and is, for example, a communication interface. For example, the communication unit 101 receives an instruction to start processing, teacher data, and the like from a terminal of the administrator. The communication unit 101 outputs the learning result, the prediction result after learning, and the like to the terminal of the administrator.

The storage unit 102 is an example of a storage device that stores programs and data, and is, for example, a memory or a hard disk. The storage unit 102 stores an attendance list data database (DB) 103, a data for learning DB 104, a learning result DB 105, a prediction target DB 106, and setting information 107.

The attendance list data DB 103 is a database that stores work data relating to the work of employees and the like. The work data stored is obtained by converting the attendance record used in each company into data, and may be acquired from various known attendance management systems and the like. For example, the attendance list data DB 103 stores, as work data, employee ID, date, working mode such as holidays/work (work days)/non-work (work days), time of arrival at work, time of departure from work, and the like.

The data for learning DB 104 is a database that stores data for learning such as teacher data for training the classifier model 10. For example, the data for learning DB 104 stores the work data 1 which is generated from the attendance list of each employee as in the attendance list data DB 103, and to which the positive example or the negative example is assigned as correct answer information.

The data of the attendance list data DB 103 and the data for learning DB 104 stored here may be generated by another device other than the learning device 100, or may be generated by the learning device 100.

The learning result DB 105 is a database that stores learning results. For example, the learning result DB 105 stores parameters and the like used in the intermediate layers 11b of the classifier model 10 trained by machine learning.

The prediction target DB 106 is a database that stores the work data 3 of a target (employee) whose presence or absence of medical care is predicted using the trained classifier model 10. For example, the prediction target DB 106 stores the work data 3 concerning the employee serving as the prediction target extracted from the attendance list data DB 103.

The setting information 107 indicates setting items set in advance by the user via a terminal of the administrator or the like. For example, the setting items in the setting information 107 include items included in the attendance list data DB 103 such as employee ID, date, working mode such as holidays/work (work days)/non-work (work days), time of arrival at work, time of departure from work, and the like. The setting items in the setting information 107 include conditions (size, length, arrangement position, angle, and the like of each element included in the figure) and the like used at the time of generating the work result graphic data 2 and 4.

The control unit 110 is a processing unit that controls the process of the entire learning device 100, and is, for example, a processor. The control unit 110 includes a data acquisition unit 111, a graphic data generation unit 112, a learning unit 113, and a prediction unit 114. The data acquisition unit 111, the graphic data generation unit 112, the learning unit 113, and the prediction unit 114 are an example of a process executed by an electronic circuit or processor included in a processor or the like.

The data acquisition unit 111 is a processing unit that acquires data to be processed in the learning phase (S1) and the prediction phase (S2). For example, the data acquisition unit 111 acquires the work data 1 with correct answer information from the data for learning DB 104 in the learning phase (S1). The data acquisition unit 111 acquires the work data 3 of the prediction target from the prediction target DB 106 in the prediction phase (S2).

The graphic data generation unit 112 is a processing unit that performs the process (S11, S21) of creating chronological figures from chronological data of the work data 1 or the work data 3 and generates the work result graphic data 2 or the work result graphic data 4.

For example, the graphic data generation unit 112 generates the work result graphic data 2 and 4 in which events included in the chronological data (for example, working mode such as holidays/work (work days)/non-work (work days), time of arrival at work, time of departure from work) are disposed in chronological order along the circumferential direction with respect to the center based on the chronological data of the work data 1 and the work data 3. For example, the graphic data generation unit 112 sequentially reads out events indicated by the chronological data of the work data 1 and the work data 3, converts the events into figures (for example, shaded) corresponding to the events, and then arranges the figures along the circumferential direction with respect to the center.

With respect to the corresponding event positions (for example, Mondays, Tuesdays . . . ) in respective cycles in which the predetermined time unit (for example, one week) is one cycle, the graphic data generation unit 112 arranges, in the work result graphic data 2 and 4, the corresponding event positions in adjacent cycles closely to each other in the radial direction with respect to the center. The predetermined time unit is set in advance in the setting information 107 or the like.

For example, the graphic data generation unit 112 arranges events for one week from Sunday to Saturday over one round in the circumferential direction (for example, assuming 0:00 on Sunday as 0° and 24:00 on Saturday as 360°). Next, the graphic data generation unit 112 similarly arranges events for the next one week on the outer circumference or the inner circumference with respect to the current circumference, and generates the work result graphic data 2 and 4 into a circular figure such as a concentric shape, spiral shape or the like.

As a result, in the work result graphic data 2 and 4, the events continuing in chronological order and the corresponding event positions in respective cycles are arranged in the vicinity of each other in the figure.

In the work result graphic data 2, the graphic data generation unit 112 may set the interval between events arranged in chronological order along the circumferential direction and the interval between event positions arranged closely to each other in the radial direction based on the size of the convolution filter. For example, the graphic data generation unit 112 acquires the setting size (m×m) of the convolution filter in the convolution layer of the neural network 11 with reference to the setting information 107 and the like. Next, the graphic data generation unit 112 sets event intervals in the circumferential direction and the radial direction so that a predetermined number of events are included in the size of m×m in the convolution filter in the circumferential direction and the radial direction. As a result, the graphic data generation unit 112 may generate the work result graphic data 2 in which the adjacent events in chronological order and the corresponding events in the adjacent cycles fit in the convolution filter.

The learning unit 113 performs supervised learning with teacher data on the neural network 11 by using a deep learning method such as an error back propagation method for causing the multi-layered neural network 11 to learn in the learning phase (S1).

For example, in the error back propagation method generally used in supervised learning, the learning unit 113 inputs the work result graphic data 2 for learning to the input layer 11a and causes the neural network 11 to propagate it in a forward direction. Next, the learning unit 113 compares the classification result obtained from the output layer 11c with the correct answer (positive example/negative example) to obtain an error. In the error back propagation method, the neural network 11 is caused to propagate the error between the classification result and the correct answer in the opposite direction to that at the time of classification, and the parameters of each layer of the neural network 11 are changed to approach the optimal solution. Thereafter, when the learning is completed, the learning unit 113 stores various parameters of the neural network 11 in the learning result DB 105 as a learning result.

The prediction unit 114 is a processing unit that predicts the label of data to be discriminated using the learning result in the prediction phase (S2). For example, the prediction unit 114 reads various parameters concerning the neural network 11 from the learning result DB 105, and constructs the classifier model 10 in which the various parameters are set. The prediction unit 114 inputs the work result graphic data 4 generated from the work data 3 of the prediction target to the input layer 11a of the classifier model 10 that has been constructed. Next, the prediction unit 114 outputs, from the output layer 11c of the classifier model 10, the result of classification as to whether to receive medical care. The prediction unit 114 displays the prediction result on the display or transmits the prediction result to the terminal of the administrator.

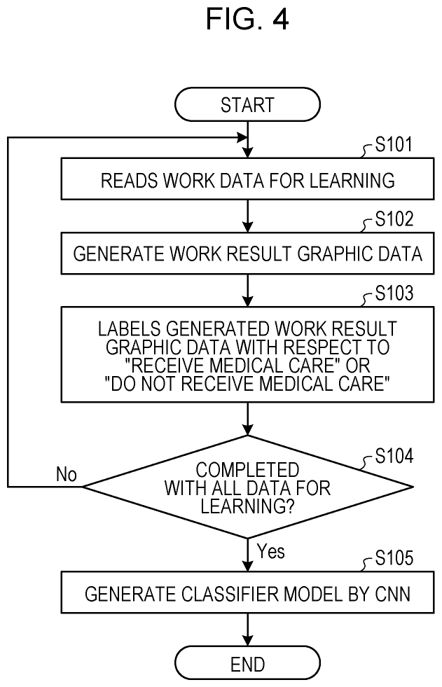

FIG. 4 is a flowchart illustrating an example of the learning phase. As illustrated in FIG. 4, when the learning phase (S1) is started, the data acquisition unit 111 reads the work data 1 for learning with reference to the data for learning DB 104 (S101). For example, the data acquisition unit 111 reads the work data 1 (for example, the work situation of a given employee who is a positive example or a negative example) for each case to which the positive example or the negative example is assigned. Next, the graphic data generation unit 112 generates the work result graphic data 2 based on the read the work data 1 (S102).

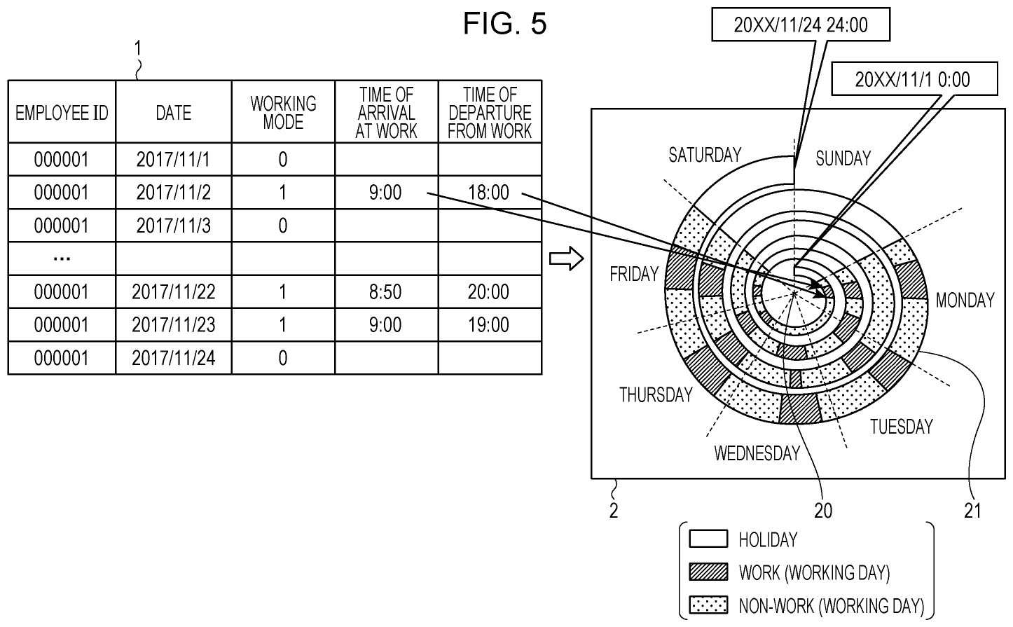

FIG. 5 is an explanatory diagram for explaining an example of generation of the work result graphic data 2 from the work data 1. As illustrated in FIG. 5, the graphic data generation unit 112 generates the work result graphic data 2 including the chronological figure 21 in which events included in the work data 1 (working mode such as holidays/work (work days)/non-work (work days), time of arrival at work, time of departure from work, and the like) are arranged in chronological order along the circumferential direction with respect to a center 20. In the chronological figure 21, the events from Sunday to Saturday are arranged over one round with 0:00 on Sunday as 0° and 24:00 on Saturday as 360°, and events of the next week are arranged outside thereof in the form of a spiral. In the illustrated example, the chronological figure 21 in which the events are arranged in a spiral shape outward from the center 20 is illustrated, but the arrangement example of the events is not limited to the above. For example, events may be arranged in a spiral shape from the outside toward the center 20.

Respective days of the first week and respective days of the second week, which is after the first week, are arranged so that the same days of the first week and the second week are located at radially corresponding positions from the center of the figure of the spiral shape. For example, the position of Monday in the first week correspond to the position of Monday in the second week, the position of Tuesday in the first week correspond to the position of Tuesday in the second week, and the position of Wednesday in first week corresponds to the position of Wednesday in the second week. Similarly, for the third and subsequent weeks, respective positions of the same day of the week correspond with each other radially from the center of the figure. The positions of the events that occur on the same day of the week correspond with each other radially from the center of the figure of the spiral shape.

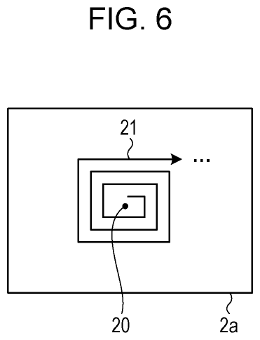

FIG. 6 is an explanatory diagram of an example of work result graphic data. As illustrated in FIG. 6, the graphic data generation unit 112 may generate the work result graphic data 2a which represents the spiral chronological figure 21 whose angle is changed at right angles.

The graphic data generation unit 112 may create a plurality of pieces of work result graphic data 2 by shifting the period. For example, in the example of FIG. 5, the work result graphic data 2 in which the event from November 1 is represented by the chronological figure 21 is generated, but a plurality of pieces of work result graphic data 2 may be generated by shifting the period by one round as in from November 8, from November 15 and so on. By generating a plurality of pieces of work result graphic data 2 by shifting the period in this manner, discrimination caused by the difference in event size between the center 20 of the chronological figure 21 and the outer side may be corrected.

Returning to FIG. 4, next to S102, the graphic data generation unit 112 labels the generated work result graphic data 2 with respect to “receive medical care” or “do not receive medical care” based on the correct answer information (positive example or negative example) assigned to the work data 1 (S103).

Next, the graphic data generation unit 112 determines whether the process has been completed for all the data for learning included in the data for learning DB 104 (S104), and if not completed (S104: NO), the process returns to S101.

When completed (S104: YES), the learning unit 113 generates the classifier model 10 from the CNN based on the work result graphic data 2 after the labeling (S105).

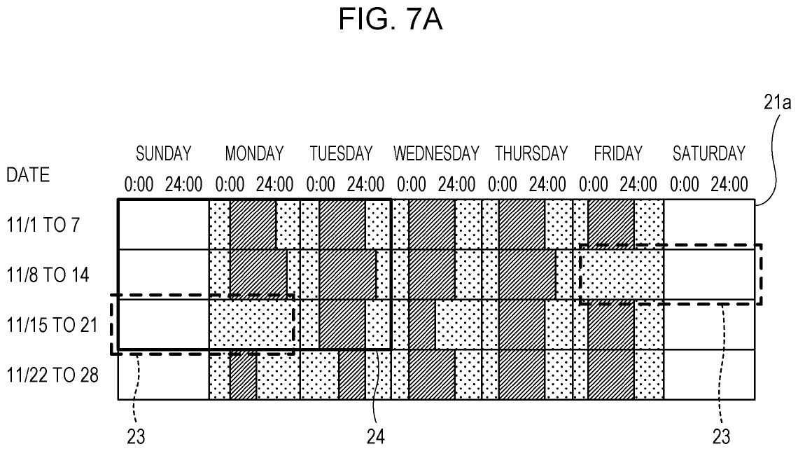

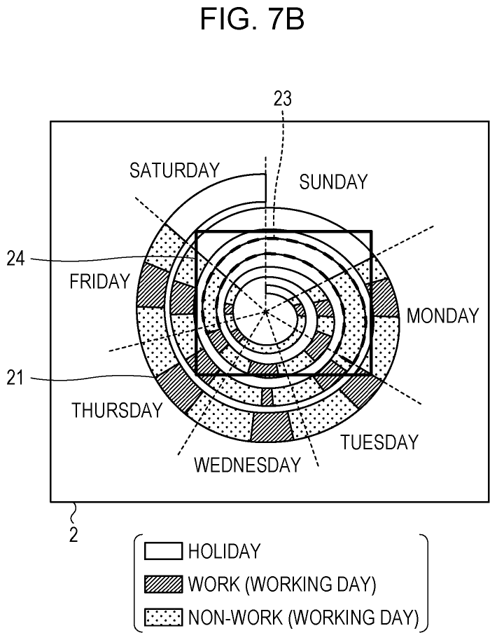

FIG. 7A is an explanatory diagram exemplifying work result graphic data of the related art. As illustrated in FIG. 7A, the chronological figure 21a in work result graphic data of the related art is divided into, for example, segments each composed of Sunday to Saturday. For this reason, when CNN learning is performed with the chronological figure 21a, a feature portion 23 from Friday to Monday may not fit in a convolution filter 24. Therefore, in the work result data of the related art, CNN learning may not progress for the feature portion 23 from Friday to Monday, and the determination accuracy may be low.

A person who will receive medical care tends to take time off work in a fixed pattern for the time unit. When the continuity of the cyclic time unit is disconnected as in the calendar, the periodicity of occurrence of the event may not be learned. For example, when an event occurs every 10 days, since the calendar is made with every week, the event is shifted by three days in the next week. For this reason, the determination accuracy of the learned model for determining whether an event occurs with respect to an event that occurs in a cycle different from the cyclic time unit is lowered.

FIG. 7B is an explanatory diagram exemplifying the work result graphic data 2 generated by the learning device 100 according to the embodiment. As illustrated in FIG. 7B, in the chronological figure 21 of the work result graphic data 2, events continuing in chronological order and corresponding event positions in respective cycles are arranged in the vicinity of each other. Therefore, in the case of performing CNN learning using the chronological figure 21, since a feature portion 23 from Friday to Monday fits in a convolution filter 24, CNN learning may be performed with respect to the feature portion 23.

This makes it possible to learn the tendency of a person who will receive medical care with respect to the event for each day of the week that constitutes the time unit. It is possible to learn the tendency of a person who will receive medical care with respect to an event that occurs in a cycle different from the cyclic time unit.

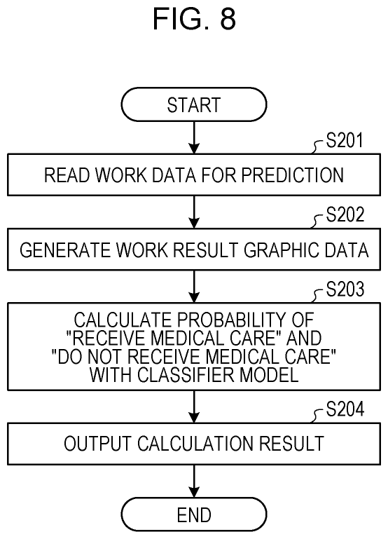

FIG. 8 is a flowchart illustrating an example of the prediction phase. As illustrated in FIG. 8, when the process of the prediction phase is started, the data acquisition unit 111 reads the work data 3 for prediction with reference to the prediction target DB 106 (S201). Next, based on the work data 3 read out, the graphic data generation unit 112 performs the same process as in S102, and generates the work result graphic data 4 (S202).

Next, the prediction unit 114 reads various parameters concerning the neural network 11 from the learning result DB 105, and constructs the classifier model 10 in which the various parameters are set. Next, the prediction unit 114 inputs the work result graphic data 4 into the constructed classifier model 10 to calculate the probabilities of “receiving medical care” and “not receiving medical care” (S203), and acquires calculation results (classification results) from the output layer 11c of the classifier model 10. Next, the prediction unit 114 outputs the calculation results by displaying the calculation results on a display or by transmitting the calculation results to the terminal of the administrator (S204).

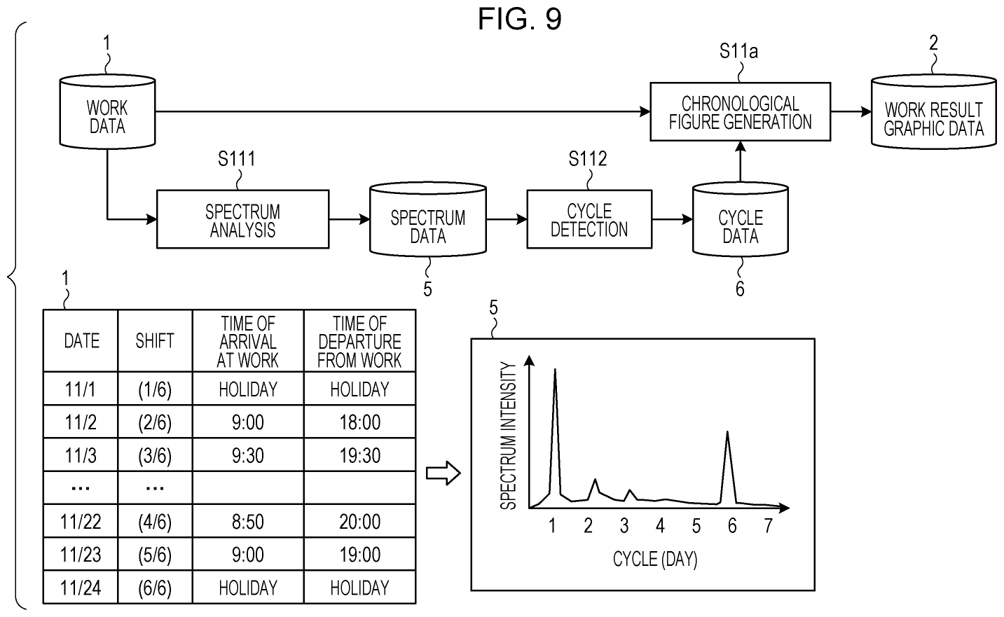

When the work result graphic data 2 is generated, a cycle detected based on an analysis result by the spectrum analysis of the graphic data generation unit 112 may be used as the time unit of one cycle. FIG. 9 is an explanatory diagram for explaining generation of a figure using a spectrum analysis result.

As illustrated in FIG. 9, the graphic data generation unit 112 performs a spectrum analysis on the work data 1 under predetermined conditions (for example, on holidays) (S111). As a result, the graphic data generation unit 112 acquires spectrum data 5 indicating the spectrum intensity (for example, strong when it is a holiday) for each cycle (day) as an analysis result.

Next, the graphic data generation unit 112 detects a cycle based on the obtained spectrum data 5 (S112), and acquires cycle data 6. For example, when spectrum data 5 in which the person takes one day off after working 3 days is obtained by spectrum analysis of the work data 1, cycle data 6 of a 4-day cycle is acquired. Next, the graphic data generation unit 112 generates a chronological figure in the time unit in which the obtained cycle data 6 is one cycle (S11a), and generates the work result graphic data 2. As a result, the feature cycle obtained by the spectrum analysis of the work data 1 may be made one cycle without the administrator or the like setting the cycle as the setting information 107 in advance.

As described above, the learning device 100 generates the work result graphic data 2 as data for learning for training of the classifier model 10 using the convolutional neural network based on the work data 1 for learning. For example, the learning device 100 arranges the events included in the work data 1 in chronological order along the circumferential direction with respect to the center 20 in the work result graphic data 2. With respect to the corresponding event positions in each cycle in which the predetermined time unit in the work data 1 is one cycle, the learning device 100 arranges, in the work result graphic data 2, the corresponding event positions in adjacent cycles closely to each other in the radial direction with respect to the center 20.

As a result, in the work result graphic data 2 used for training of the classifier model 10, the events continuing in chronological order in the work data 1 are arranged in the vicinity in the figure. For example, since the work result graphic data 2 is not divided by the break of one week from Sunday to Saturday in the calendar, the event across the break is not arranged apart. For this reason, the work result graphic data 2 makes it possible to express the regularity of the event across the weekend break, for example, the event from Friday to Monday. Therefore, by using the work result graphic data 2 for training of the classifier model 10, it is possible to advance learning of an event or the like crossing a weekend break, and it is possible to suppress deterioration of the discrimination accuracy of the classifier model 10.

The learning device 100 generates the work result graphic data 2 in which events included in the work data 1 are arranged in a spiral with respect to the center 20. As a result, in the work result graphic data 2, the events continuing in chronological order in the work data 1 are arranged in a spiral without a break. Therefore, learning of events may be performed without a break in chronological order by using the work result graphic data 2 for training of the classifier model 10, and the discrimination accuracy of the classifier model 10 may be improved.

The learning device 100 sets an interval of events arranged in chronological order and an interval of event positions arranged closely to each other in the radial direction in the work result graphic data 2 based on the convolution filter size of the classifier model 10. As a result, the learning device 100 may generate the work result graphic data 2 so that the adjacent events in chronological order and the corresponding events in the adjacent cycles may be included in the convolution filter. Therefore, by using the work result graphic data 2 for training of the classifier model 10, it is possible to perform learning in which the adjacent events in chronological order and the corresponding events in the adjacent cycles are featured, and it is possible to improve the discrimination accuracy of the classifier model 10.

With respect to the corresponding event positions in respective cycles in which the cycle detected based on the spectrum analysis of the work data 1 is one cycle, the learning device 100 arranges the corresponding event positions in the adjacent cycles closely to each other in the radial direction with respect to the center 20. As a result, the learning device 100 may generate the work result graphic data 2 in which the feature cycle obtained by the spectrum analysis of the work data 1 may be made one cycle.

The learning device 100 generates the work result graphic data 2 for training of the classifier model 10 from the work data 1 in which work situations of employees are recorded, so that, for example, it is possible to train the classifier model 10 that determines the presence or absence of medical care from the work situation of the employee.

With respect to the day positions of the calendar in which one week is one cycle, the learning device 100 generates the work result graphic data 2 in which the corresponding days in adjacent weeks are arranged closely to each other in the radial direction with respect to the center 20. In this way, by using the work result graphic data 2 for training of the classifier model 10, it is possible to perform learning of the correlation of the event having the feature between the days of the week.

The respective components of the illustrated devices do not necessarily have to be physically configured as illustrated. Specific forms of the separation and integration of the devices are not limited to the illustrated forms, and all or a portion thereof may be separated and integrated in any units in either a functional or physical manner depending on various loads, usage states, and the like.

All or given part of the various processing functions performed by the learning device 100 may be implemented on a central processing unit (CPU) (or a microcomputer such as a micro-processing unit (MPU) or a micro controller unit (MCU)). Naturally, all or given part of the various processing functions may be executed on a program analyzed and executed by a CPU (or a microcomputer such as an MPU or an MCU) or on hardware by wired logic. The various processing functions performed by the learning device 100 may be executed by a plurality of computers in cooperation by cloud computing.

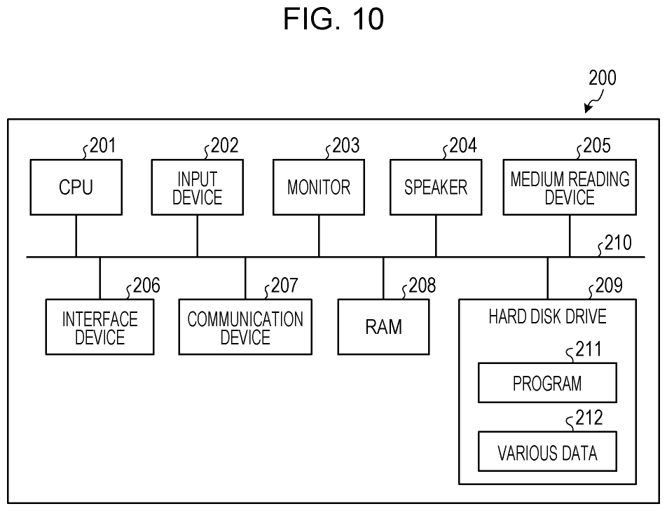

The various processes described in the above embodiments may be implemented by executing, on a computer, a program prepared in advance. Hereinafter, an example of a computer (hardware) which executes a program which has the same function as the above embodiment will be explained. FIG. 10 is a diagram illustrating an example of a computer that executes a program.

As illustrated in FIG. 10, a computer 200 includes a CPU 201 that executes various arithmetic processing, an input device 202 that receives data input, a monitor 203, and a speaker 204. The computer 200 also includes a medium reading device 205 that reads a program or the like from a storage medium, an interface device 206 for connecting the computer 200 to various devices, and a communication device 207 for communication connection with an external device via wire or wirelessly. The computer 200 also has a random access memory (RAM) 208 that temporarily stories various kinds of information, and a hard disk device 209. Each unit (201 to 209) in the computer 200 is connected to a bus 210.

The hard disk device 209 stores programs 211 for executing various processes in the data acquisition unit 111, the graphic data generation unit 112, the learning unit 113, the prediction unit 114, and the like described in the above embodiments. The hard disk device 209 stores various data 212 to which the programs 211 refer. The input device 202 receives, for example, an input of operation information from an operator of the computer 200. The monitor 203 displays, for example, various screens operated by the operator. The interface device 206 is connected to, for example, a printing device. The communication device 207 is connected to a communication network such as a local area network (LAN), and exchanges various kinds of information with an external device via the communication network.

The CPU 201 reads out the programs 211 stored in the hard disk device 209 to deploy and execute the read programs 211 on the RAM 208, thereby executing various processes in the data acquisition unit 111, the graphic data generation unit 112, the learning unit 113, the prediction unit 114, and the like. The programs 211 may not be stored in the hard disk device 209. For example, the computer 200 may read and execute the programs 211 stored on a storage medium readable by the computer 200. The storage medium readable by the computer 200 corresponds to, for example, a portable recording medium such as a compact disc read-only memory (CD-ROM), a digital versatile disc (DVD), a Universal Serial Bus (USB) memory, a semiconductor memory such as a flash memory, a hard disk drive, or the like. The programs 211 may be stored in a device connected to a public network, the Internet, a LAN, or the like, and the computer 200 may read and execute the programs 211 from the device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data generation method executed by a computer, the data generation method comprising:
accepting chronological data having a first cycle including a set of unit times of a predetermined number; and
generating image data including a figure generated based on the chronological data, wherein
the figure is generated such that respective sets of unit times included in the chronological data are arranged in a spiral in chronological order and unit times corresponding to a same position within the first cycle are radially aligned from the center of the spiral.

2. The data generation method of claim 1, wherein the image data is data for learning for a convolutional neural network including a convolution layer in which a convolution operation is performed on neuron data that have been input to the convolutional neural network.

3. The data generation method of claim 2, wherein the generating includes setting, based on a convolution filter size of the convolutional neural network, a first interval between events arranged in chronological order along a circumferential direction with respect to the center and a second interval between events arranged closely to each other in a radial direction with respect to the center of the spiral.

4. The data generation method of claim 1, wherein the generating includes setting a cycle detected based on a spectrum analysis of the chronological data as the first cycle.

5. The data generation method of claim 1, wherein the chronological data is work data in which a work situation of an employee is recorded.

6. The data generation method of claim 5, wherein:
the first cycle is one week and a unit time is a day within a week of a calendar; and
the generating includes generating, with respect to a day position of the calendar, the figure in which corresponding days in adjacent weeks are arranged closely to each other in the radial direction with respect to the center of the spiral.

7. The data generation method of claim 5, further comprising:
changing a weight of at least one of a convolution layer, a pooling layer, and a connected layer in the convolutional neural network by using a feature part in the figure; and
generating a learned model for predicting a person who is to receive medical care from events that have occurred in cyclic time units.

8. A non-transitory, computer-readable recording medium having stored therein a program for causing a computer to execute a process comprising:
accepting chronological data having a first cycle including a set of unit times of a predetermined number; and
generating image data including a figure generated based on the chronological data, wherein
the figure is generated such that respective sets of unit times included in the chronological data are arranged in a spiral in chronological order and unit times corresponding to a same position within the first cycle are radially aligned from the center of the spiral.

9. The non-transitory, computer-readable recording medium of claim 8, wherein the image data is data for learning for a convolutional neural network including a convolution layer in which a convolution operation is performed on neuron data that have been input to the convolutional neural network.

10. The non-transitory, computer-readable recording medium of claim 9, wherein the generating includes setting, based on a convolution filter size of the convolutional neural network, a first interval between events arranged in chronological order along a circumferential direction with respect to the center of the spiral and a second interval between events arranged closely to each other in a radial direction with respect to the center.

11. The non-transitory, computer-readable recording medium of claim 8, wherein the generating includes setting a cycle detected based on a spectrum analysis of the chronological data as the first cycle.

12. The non-transitory, computer-readable recording medium of claim 8, wherein the chronological data is work data in which a work situation of an employee is recorded.

13. The non-transitory, computer-readable recording medium of claim 12, wherein:
the first cycle is one week and a unit time is a day within a week of a calendar; and
the generating includes generating, with respect to a day position of the calendar, the figure in which corresponding days in adjacent weeks are arranged closely to each other in the radial direction with respect to the center of the spiral.

14. The non-transitory, computer-readable recording medium of claim 12, the process further comprising:
changing a weight of at least one of a convolution layer, a pooling layer, and a connected layer in the convolutional neural network by using a feature part in the figure; and
generating a learned model for predicting a person who is to receive medical care from events that have occurred in cyclic time units.

15. A non-transitory, computer-readable recording medium having stored therein a data structure for causing a computer to execute a process using the data structure, the data structure comprising:
graphic data in which, based on chronological data having a first cycle including a set of unit times of a predetermined number, respective sets of unit times included in the chronological data are arranged in a spiral in chronological order and unit times corresponding to a same position within the first cycle are radially aligned from the center of the spiral; and
correct answer information assigned to the graphic data, wherein the process includes:
inputting, as data for learning, the graphic data and the correct answer information to an input layer of a convolutional neural network,
outputting an output value indicating a calculation result from an output layer of the convolutional neural network, and
performing learning based on a comparison between the correct answer information and the output value.
